(19) United States
(12) Patent Application Publication
(10) Pub. No.: US 2025/0148879 A1
(43) Pub. Date: May 8, 2025

(54) GAME SYSTEM AND SERVER

(71) Applicant: SEGA CORPORATION, Tokyo (JP)

(72) Inventors: Taro TAMUKAI, Tokyo (JP); Norihiro SAITO, Tokyo (JP); Nobuyuki TAKANO, Tokyo (JP); Mitsuharu FUKAZAWA, Tokyo (JP); Takaya GOSHOZONO, Tokyo (JP); Takayoshi SUZUKI, Tokyo (JP); Yusuke ORIMA, Tokyo (JP); Masaya NAKANO, Tokyo (JP); Shuhei NAKAYAMA, Tokyo (JP)

(21) Appl. No.: 19/018,710

(22) Filed: Jan. 13, 2025

Related U.S. Application Data
(63) Continuation of application No. PCT/JP2023/008253, filed on Mar. 6, 2023.

(30) Foreign Application Priority Data
Jul. 15, 2022 (JP) 2022-114300

(51) Int. Cl. G07F 17/32; A63F 9/30

(52) U.S. Cl. CPC G07F 17/3297; A63F 9/30; G07F 17/3237

(57) ABSTRACT

A game system includes a plurality of object acquisition game machine and a server. Each object acquisition game machine includes: a game field including a first area in which an object to be acquired is placed and a second area to which the object is to be moved; an object holder that holds the object; an operation unit that receives operation performed by a player; a movement controlling unit that drives the object holder in accordance with the operation; and a movement determining unit that determines whether or not movement of the object to the second area is successful. The server includes: a play information obtaining unit that obtains play information containing a game machine ID identifying an object acquisition game machine, a player ID identifying a player, and a play result of a crane game; and a bonus providing unit that gives a bonus to a player when the play information collected for the player satisfies a bonus condition.

### CROSS REFERENCE TO RELATED APPLICATION

This application is a continuation application of International Patent Application No. PCT/JP2023/008253, filed on Mar. 6, 2023, claiming priority from Japanese Patent Application No. 2022-114300, filed on Jul. 15, 2022 in the Japan Patent Office, the contents of which being incorporated by reference herein in their entirety.

### BACKGROUND

The present disclosure relates to an object acquisition game in which an object such as a prize is acquired.

Many game arcades have crane game machines (object acquisition game machines). A crane game machine (object acquisition game machine) has a housing in which a stage (game field) is provided. Prizes (objects) such as stuffed toys and sweets are placed on the stage. A player operates an object holder such as a claw (crane) by using lateral and longitudinal direction buttons and the like. If the player can grab a prize with the claw and move the prize to a chute, the player wins the prize.

Before playing, a player obtains credits by paying a play fee. A credit is a right to attempt the crane game. A player having three credits can attempt the crane game three times (refer to JP 6859784 B2).

Whether or not a player can win a prize in a crane game highly depends on the skill of the player. Some players may therefore end up not being able to win a prize even though they have spent a lot of credits. A player with a poor skill who has experienced such a sense of loss and frustration may lose the motivation to try the crane game again.

### SUMMARY

It is an aspect to propose a technology for keeping encouraging players to try an object acquisition game machine.

A game system according to an aspect of some embodiments includes a plurality of object acquisition game machines and a server.

Each of the object acquisition game machines includes: a game field located in a play space and including a first area in which an object to be acquired is placed and a second area to which the object is to be moved; an object holder configured to hold the object; an operation unit configured to receive operation performed by a player; a movement controlling unit configured to drive the object holder in accordance with the operation; and a movement determining unit configured to determine whether or not movement of the object to the second area is successful.

The server includes: a play information obtaining unit configured to obtain play information containing a game machine ID for identifying an object acquisition game machine, a player ID for identifying a player, and a play result of an object acquisition game; and a bonus providing unit configured to give a bonus to a player when a bonus condition based on the play information collected for the player is satisfied.

### BRIEF DESCRIPTION OF DRAWINGS

FIG. 1 is a hardware configuration diagram of a game system;

FIG. 2 is a diagram schematically illustrating an overall configuration of a crane game machine (object acquisition game machine);

FIG. 3 is a functional block diagram of a server;

FIG. 4 is a functional block diagram of a crane game machine (object acquisition game machine);

FIG. 5 is a screen diagram of an initial screen;

FIG. 6 is a sequence diagram illustrating processes of pairing;

FIG. 7 is a data structure diagram of pairing information;

FIG. 8 is a data structure diagram of machine group information;

FIG. 9 is a data structure diagram of held point information;

FIG. 10 is a data structure diagram of prize value information; and

FIG. 11 is a screen diagram of a prize exchange screen.

### DETAILED DESCRIPTION

According to some embodiments, a game system may include a plurality of object acquisition game machines and a server. Each of the object acquisition game machines may include: a game field located in a play space and including a first area in which an object to be acquired is placed and a second area to which the object is to be moved; an object holder configured to hold the object; an operation unit configured to receive operation performed by a player; a movement controlling unit configured to drive the object holder in accordance with the operation; and a movement determining unit configured to determine whether or not movement of the object to the second area is successful. The server may include: a play information obtaining unit configured to obtain play information containing a game machine ID for identifying an object acquisition game machine, a player ID for identifying a player, and a play result of an object acquisition game; and a bonus providing unit configured to give a bonus to a player when a bonus condition based on the play information collected for the player is satisfied.

According to some embodiments, a game controlling method may include: obtaining, by a computer, play information containing a game machine ID for identifying an object acquisition game machine, a player ID for identifying a player, and a play result of an object acquisition game; calculating, by the computer, a cumulative total of play results of object acquisition games for each player; increasing, by the computer, points held by each player depending on the cumulative total of the play results of the player; and when an instruction to exchange the points with an object is made by a player, decreasing, by the computer, the points held by the player as a result of providing the object.

Various embodiments facilitate keeping encouraging players to try an object acquisition game machine.

Hereinafter, a configuration and basic functions of a crane game machine (claw machine), which is one example of an object acquisition game machine, will be first described. Next, two functions of the crane game machine (object acquisition game machine) according to an embodiment, which are a “pairing function” and a “playpoint function”, will be sequentially described. Note that an “object holder” is not limited to a suspended type such as a crane (claw) but may be a hook type or a pushing type for catching or pushing a prize or the like from a side, for example. In the embodiment described below, an example of a crane will be explained.

The pairing function is a function of associating a crane game machine (object acquisition game machine) with a player and is an idea similar to login, details of which will be described later. The playpoint function is a function of giving a bonus to a player depending on his/her play history of the crane game.

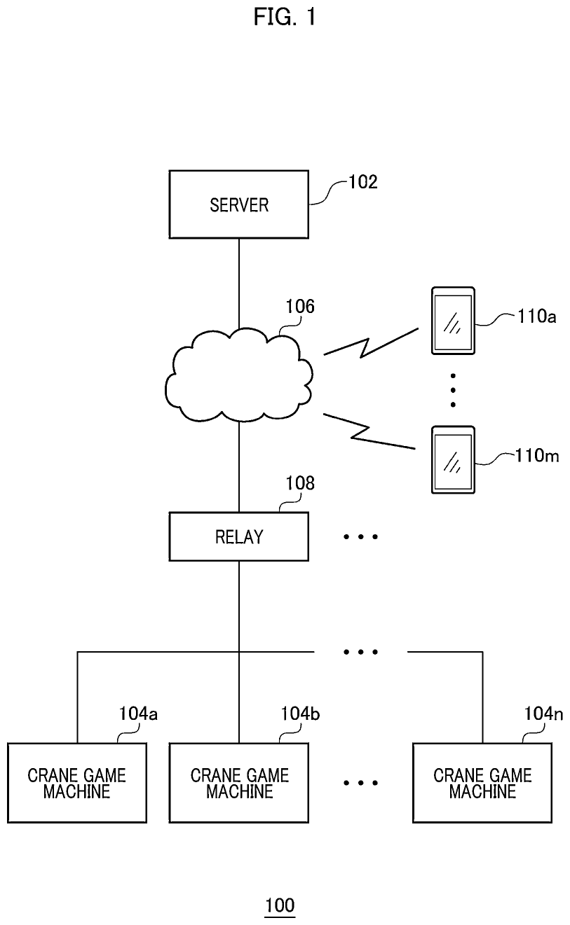

FIG. 1 is a hardware configuration diagram of a game system 100.

In the game system 100, a plurality of crane game machines (object acquisition game machines) 104a, 104b, . . . , 104n (hereinafter referred to as “crane game machines (object acquisition game machines) 104” or a “crane game machine (object acquisition game machine) 104” when the crane game machines (object acquisition game machines) are collectively referred to or need not particularly be distinguished from each other) and user terminals 110a, . . . , 110m (hereinafter referred to as “user terminals 110” or a “user terminal 110” when the user terminals are collectively referred to or need not particularly be distinguished from each other) are connected to a server 102 via the Internet 106.

The crane game machines (object acquisition game machines) 104 are connected with the server 102 via a relay 108. The relay 108 is a device that receives and transmits information to relay information between the server 102 and the crane game machines (object acquisition game machines) 104 and performs some functions of a server. A relay 108 is installed in every store or on each floor of each store, and is connected with one or more crane game machines (object acquisition game machines) 104. Note that the functions of a relay 108 may be integrated in the server 102 or the functions of the server 102 may be distributed to the relays 108 so that the relays 108 function as the server 102.

The user terminals 110 (communication terminals) in the embodiment are assumed to be smartphones. The user terminal 110 may be tablet terminals or laptop PCs. The user terminals 110 are wirelessly connected with the Internet 106, but may be connected in a wired manner. Each user terminal 110 has a dedicated application (hereinafter referred to as “CS (Crane Service) software”) installed therein.

The crane game machines (object acquisition game machines) 104 are installed in play facilities such as amusement parks and game arcades. A tablet terminal used by an operator who operates a play facility may be connected with crane game machines (object acquisition game machines) 104 so as to remotely control the crane game machines (object acquisition game machines) 104.

The server 102 provides various services for a crane game, such as the pairing function and the playpoint function mentioned above. A player downloads CS software from the server 102 to a user terminal 110. Player registration is performed at this point, and the server 102 assigns a player ID to the player. The player ID is also registered in the user terminal 110. A game machine ID for identifying a crane game machine (object acquisition game machine) 104 and a store ID for identifying a store in which the crane game machine (object acquisition game machine) 104 is installed are also registered in the server 102.

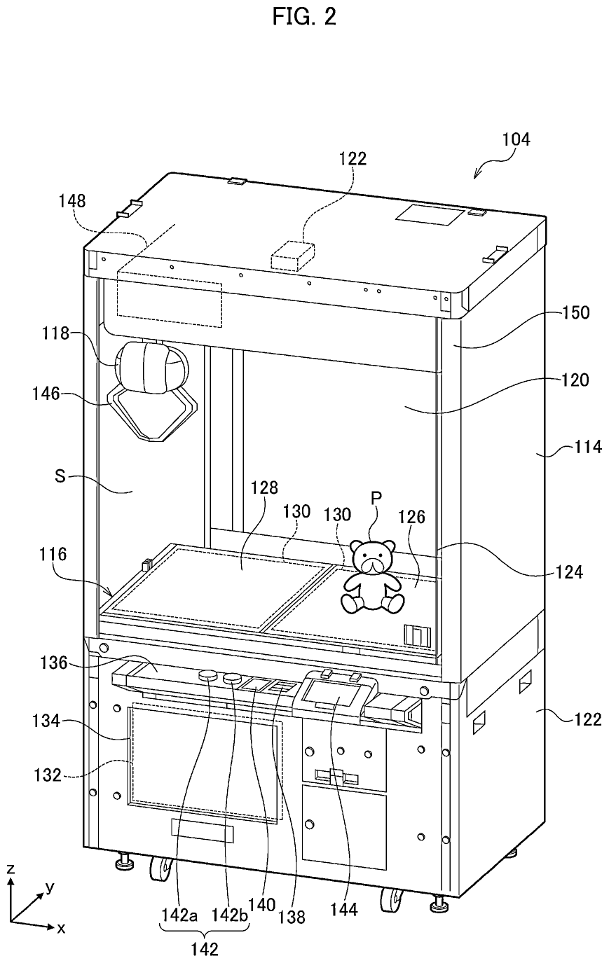

FIG. 2 is a diagram schematically illustrating an overall configuration of a crane game machine (object acquisition game machine) 104.

A crane game machine (object acquisition game machine) 104 includes a base 112 having a rectangular parallelepiped shape, and a box-like prize container 114 on the base 112. A play space S is defined in the prize container 114, in which a prize stand 116 (a game field) is located. Prizes P such as stuffed toys, goods, or the like are placed on the prize stand 116. A crane 118 is located above the prize stand 116. The crane 118 is movable in front-back, left-right and up-down directions, and can grasp and release a prize P.

The prize container 114 has a front face and left and right faces that are made of transparent glass. This is for the visibility of the prizes P from outside. A monitor 120 is installed on a back face (in the back) of the prize container 114. The monitor 120 displays various dramatic images. A camera 122 is installed on a ceiling surface of the crane game machine (object acquisition game machine) 104. The camera 122 images the prize stand 116 from above. The monitor 120 can also display images taken by the camera 122.

Light emitting diodes (LEDs) are arranged on a vertical frame 150 of the crane game machine (object acquisition game machine) 104. The LEDs are turned on as part of dramatic impact during game play. The front face of the prize container 114 has a door 124 through which an operator can put prizes P in the prize container 114.

The prize stand 116 is partitioned into a first area 126 and a second area 128. Each of the areas is constituted by a removable panel. Removal of either one of the panels can form a chute 130 through which a prize P is dropped. In a case where a prize P is placed in the first area 126 and the chute 130 is formed in the second area 128, a player can acquire the prize P if the player is able to move the prize P from the first area 126 to the second area 128 (the chute 130).

A prize accommodating space 132 for accommodating a prize P dropped through the chute 130 is formed in the base 112. A front face of the base 112 has a prize slot 134 for taking out a prize P that was dropped into the prize accommodating space 132. At least one of a sensor (an infrared sensor, a weight sensor, etc.) for detecting that a prize P has dropped and a reader for detecting an IC tag or the like attached to a prize P is provided in the prize accommodating space 132. The camera 122 may image the chute 130 or the prize accommodating space 132 to determine that a prize P has dropped and the type (a prize ID) of the dropped prize. In this case, the camera 122 may be provided on a lower part of the crane 118.

A console 136 is provided on the front face side of the base 112. The console 136 includes a coin slot 138, an integrated circuit (IC) card reader 140, an operation unit 142, and a setting display 144. For starting a game, a player drops a coin into the coin slot 138 or makes an IC card charged with electronic money touch the IC card reader 140. In the latter case, payment processing of electronic money is performed, which is a known technology and detailed description of which is omitted.

The operation unit 142 includes operation buttons 142a and 142b for a player to move the crane 118. The operation unit 142 functions as a “crane operating part” configured to receive an input signal based on an operation performed by a player. The operation button 142a is a button for moving the crane 118 in the left-right directions (X direction), and the operation button 142b is a button for moving the crane 118 in the front-back directions (Y direction). In a modification, a joystick may be used to move the crane 118 in the front-back and left-right directions.

The setting display 144 includes a touch panel. The setting display 144 receives input of setting information of a game from an operator, and displays information relating the game such as how to operate the operation unit 142 and a game result. The crane game machine (object acquisition game machine) 104 also includes a speaker (not illustrated), an external connection terminal, and others.

The crane 118 has an arm 146 capable of grasping and releasing a prize P. The crane 118 includes a motor for driving the arm 146 to open and close. The arm 146 is opened and closed to release and grasp a prize P.

The crane 118 is movable along guiderails, which are not illustrated, located at an upper part of the prize container 114, and is driven by a crane drive 148. The crane drive 148 includes a moving mechanism for driving the crane 118 in the lateral directions (X direction) and the longitudinal directions (Y direction), and a lifting mechanism for driving the crane 118 in the up-down directions (Z direction). The moving mechanism includes an X-direction motor and a Y-direction motor. The lifting mechanism includes a Z-direction motor. The crane drive 148 allows the crane 118 to be moved to an intended position in the play space S. Because such drive mechanisms are known, detailed description thereof is omitted.

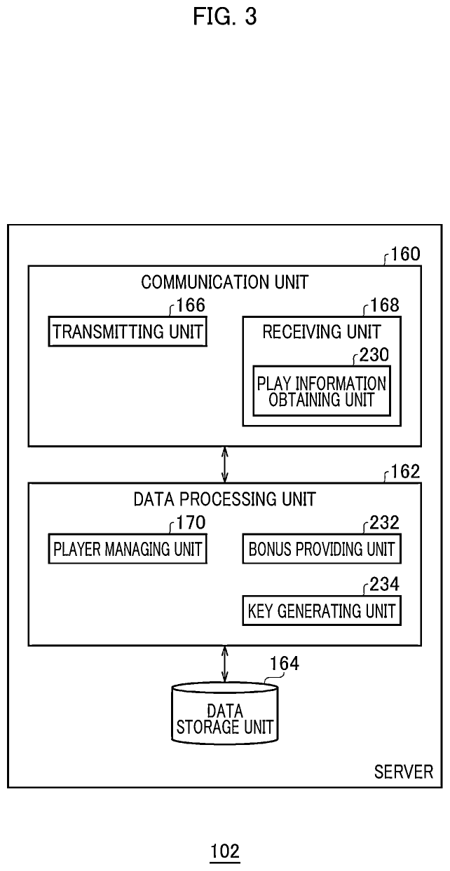

FIG. 3 is a functional block diagram of the server 102.

Respective components of the server 102 are implemented by hardware including arithmetic units such as central processing units (CPUs) and various co-processors, storage devices such as memories and storages, and wire or wireless communication lines connecting the components, and software, stored in the storage devices, for supplying processing instructions to the arithmetic units. Computer programs may be constituted by device drivers, an Operating System, various application programs on upper layers thereof, and libraries providing common functions to the programs. Blocks described below are not in units of hardware but are in units of functions.

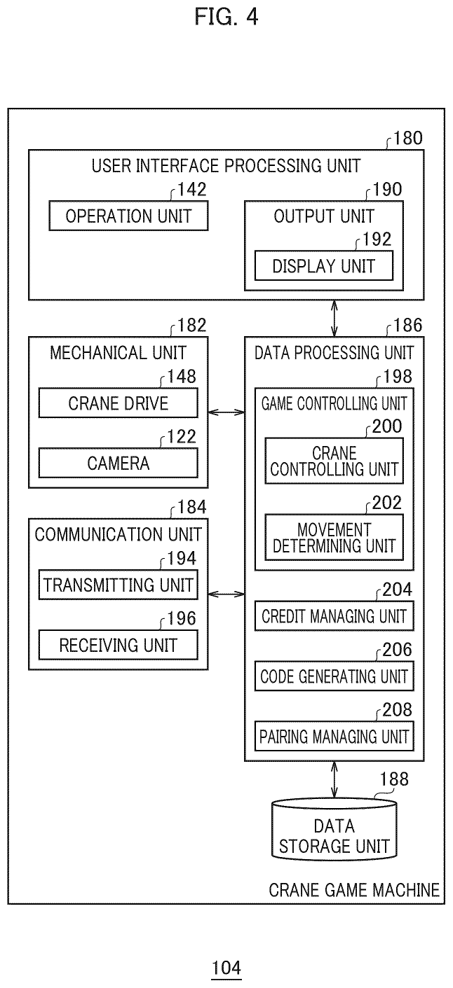

The same applies to respective components of a crane game machine (object acquisition game machine) 104 described next with reference to FIG. 4.

The server 102 includes a data processing unit 162, a data storage unit 164, and a communication unit 160. The communication unit 160 performs processing for communication with the user terminals 110 and the relays 108. The data storage unit 164 stores various data. The data processing unit 162 performs various processes on the basis of data received by the communication unit 160 and data stored in the data storage unit 164. The data processing unit 162 also functions as an interface of the communication unit 160 and the data storage unit 164.

The communication unit 160 includes a transmitting unit 166 for transmitting various data, and a receiving unit 168 for receiving data.

The receiving unit 168 includes a play information obtaining unit 230 for receiving play information from the crane game machines (object acquisition game machines) 104. Each crane game machine (object acquisition game machine) 104 transmits “play information” indicating a play result of a crane game played by a player. The play information includes a player ID and a game machine ID, and “information indicating a play result” of the crane game. In the present embodiment, a play fee, which is the price of credits, a play time, a success or failure of prize acquisition, and a prize ID for identifying an acquired prize when a prize has been acquired are included as the “information indicating a play result”. The contents of the information indicating a play result may contain any information, but preferably include at least one of the information mentioned above.

The data processing unit 162 includes a player managing unit 170, a bonus providing unit 232, and a key generating unit 234. The player managing unit 170 performs management relating to pairing and the like. The bonus providing unit 232 gives a bonus to a player on the basis of his/her play history. The key generating unit 234 generates a key code for pairing. The key code will be described later.

FIG. 4 is a functional block diagram of a crane game machine (object acquisition game machine) 104.

The crane game machine (object acquisition game machine) 104 includes a user interface processing unit 180, a mechanical unit 182, a data processing unit 186, a communication unit 184, and a data storage unit 188.

The user interface processing unit 180 receives operations performed by a player through various input devices, and performs processing relating to a user interface such as image display and audio output. The mechanical unit 182 drives various mechanisms such as the crane 118 and the prize accommodating space 132. The communication unit 184 performs processing for communication with the user terminals 110 and the relay 108. The data storage unit 188 stores various data. The data processing unit 186 performs various processes on the basis of data input from the user interface processing unit 180, data received by the communication unit 184, and data stored in the data storage unit 188. The data processing unit 186 also functions as an interface of the mechanical unit 182, the user interface processing unit 180, the communication unit 184, and the data storage unit 188.

The user interface processing unit 180 includes the operation unit 142 that receives an input performed by a player, and an output unit 190 that outputs various information such as images and audio for the player. The output unit 190 includes a display unit 192 that displays images on the setting display 144 or the like. The player operates the operation unit 142 to play the crane game.

The communication unit 184 includes a transmitting unit 194 that transmits various data to the server 102 or the like, and a receiving unit 196 that receives data. The transmitting unit 194 transmits the play information to the server 102.

The mechanical unit 182 includes the crane drive 148 and the camera 122 (imaging unit). As described above, the camera 122 installed on the ceiling of the crane game machine (object acquisition game machine) 104 images the prize stand 116 (game field). Taken images can show the location and the course of movement of a prize. In addition, display of a taken image on the monitor 120 allows the player to more accurately see the relative positions of the crane 118 and a prize. The crane drive 148 causes the movement, grasp and release of the crane 118 as described above.

The data processing unit 186 includes a game controlling unit 198, a credit managing unit 204, a code generating unit 206, and a pairing managing unit 208.

The game controlling unit 198 controls the progress of a crane game. The game controlling unit 198 includes a crane controlling unit 200 (movement controlling unit) and a movement determining unit 202. The crane controlling unit 200 instructs the crane drive 148 to move, grasp, or release a prize in accordance with an instruction made by operation of the operation unit 142. The movement determining unit 202 determines whether or not a prize has dropped through the chute 130, or in other words, whether a crane game has resulted in a win or a loss. The credit managing unit 204 converts a play fee input in the crane game machine (object acquisition game machine) 104 by a player into credits. The code generating unit 206 generates a two-dimensional code, which will be described later. The pairing managing unit 208 manages whether or not pairing is being performed and the player ID of the player being paired. In the present embodiment, pairing is managed by both of the player managing unit 170 of the server 102 and the pairing managing unit 208 of the crane game machine (object acquisition game machine) 104.

The data storage unit 188 stores game programs of crane games, and information on a state of use such as settings and a game play result.

### [Pairing Function]

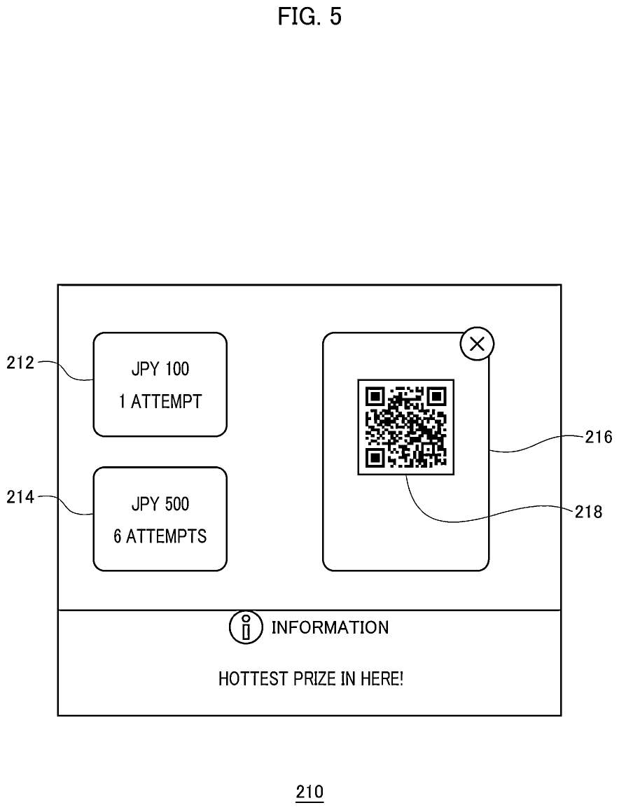

FIG. 5 is a screen diagram of an initial screen 210.

The display unit 192 causes the setting display 144 to display the initial screen 210. The setting display 144 includes a single play button 212, a multiple play button 214, and a pairing setting region 216. In the pairing setting region 216, a two-dimensional code 218 including a game machine ID and a key code is displayed. In the present embodiment, the two-dimensional code 218 will be described as a QR code (registered trademark), but may be any image from which a game machine ID and a key code can be extracted.

Before playing, the player images the two-dimensional code 218 with a camera of a user terminal 110. The CS software in the user terminal 110 extracts the game machine ID and the key code from the two-dimensional code 218, and then accesses the server 102. The server 102 thus starts pairing (to be described later). As a result of the pairing, the server 102 registers the player ID and the game machine ID in association with each other. In other words, as a result of the pairing, the crane game machine (object acquisition game machine) 104 and the player playing the crane game at the crane game machine (object acquisition game machine) 104 are associated with each other. The server 102 also notifies the crane game machine (object acquisition game machine) 104 of the player ID that is successfully paired, and the pairing managing unit 208 of the crane game machine (object acquisition game machine) 104 also registers the player ID and the game machine ID in association with each other.

After the pairing is completed, the player pays a play fee. The play fee may be paid by using coins or may be paid by using electronic money. For one attempt of the crane game, the player touches the single play button 212. After touching the single play button 212, the player pays a unit price of a credit. In the case of the crane game machine (object acquisition game machine) 104 illustrated in FIG. 5, the unit price of a credit is JPY 100. After the payment, the credit managing unit 204 generates one credit.

For six attempts of the crane game, the player touches the multiple play button 214. After touching the multiple play button 214, the player pays JPY 500 as specified. When the multiple play button 214 is touched, the credit managing unit 204 generates six credits for JPY 500 as paid. Because the player can get six credits for a play fee of five credits, it is more profitable for the player to buy six credits in bulk. Each time the crane game is played, the credit managing unit 204 subtracts one credit.

The player can get a bonus by installing the CS software in the user terminal 110, completing player registration in advance, and performing the pairing.

In the present embodiment, a playpoint function, which will be described later, is performed on the assumption that the pairing has been performed.

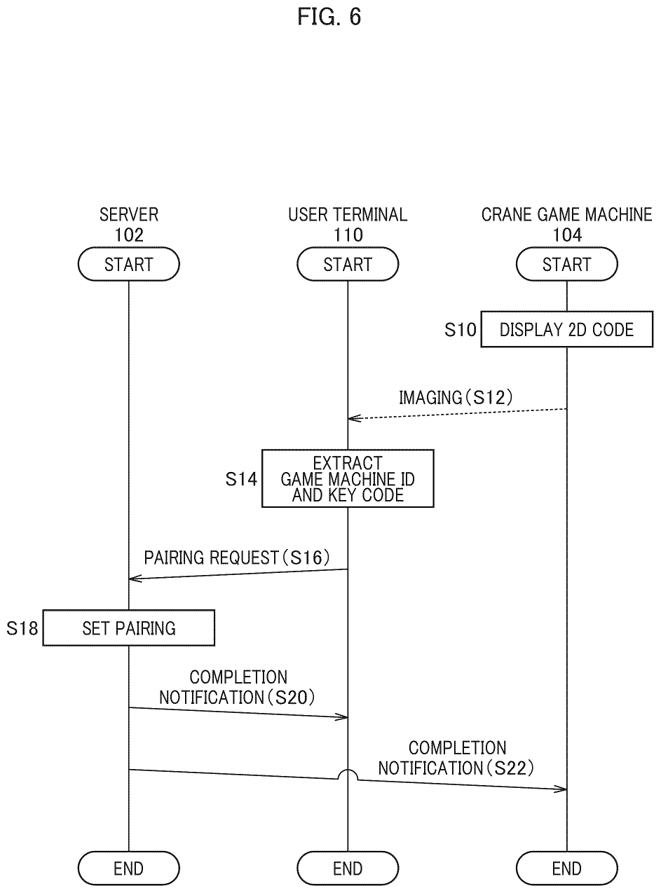

FIG. 6 is a sequence diagram illustrating processes of pairing.

First, the key generating unit 234 of the server 102 periodically generates a key code, such as at a frequency of once an hour, for example. When a new key code is generated, the transmitting unit 166 of the server 102 transmits the key code to all the crane game machines (object acquisition game machines) 104 via the relays 108. The code generating unit 206 of each crane game machine (object acquisition game machine) 104 causes a two-dimensional (2D) code 218 resulting from encoding the game machine ID and the latest key code to be displayed on the initial screen 210 (S10). A player images the two-dimensional code 218 with a user terminal 110 (S12). The CS software in the user terminal 110 extracts the game machine ID and the key code from the two-dimensional code 218 (S14), and transmits a pairing request to the server 102 (S16). The pairing request includes the game machine ID, the player ID, and the key code.

Note that the key generating unit 234 may be included in a relay 108 instead of the server 102. In this case, the relay 108 may generate a key code on the basis of unique identification information such as a serial number of the relay 108, which can prevent the key code from being the same as that for a crane game machine (object acquisition game machine) 104 connected to another relay 108. In addition, the generated key code may be transmitted from the relay 108 to the server 102 and stored in the server 102.

The receiving unit 168 of the server 102 receives the pairing request. The player managing unit 170 performs pairing setting (S18). For example, when a pairing request for pairing with a crane game machine (object acquisition game machine) 104 with a game machine ID C01 (hereinafter referred to as a “crane game machine (object acquisition game machine) 104 (C01)”) is transmitted from a player with a player ID P02 (hereinafter referred to as a “player (P02)”), the player managing unit 170 registers C01 and P02 as a “pair” in pairing information 220 (to be described later). As a result of the pairing, the server 102 can obtain the player currently playing at the crane game machine (object acquisition game machine) 104 (C01). In addition, the key code included in a pairing request matching with the latest key code issued by the server 102 or the previously issued key code is a condition for pairing. Checking of key codes will be described later.

The transmitting unit 166 of the server 102 notifies the user terminal 110 of completion of the pairing (S20). The transmitting unit 166 also notifies the crane game machine (object acquisition game machine) 104 of completion of the pairing (S22). As described above, the transmitting unit 166 notifies the crane game machine (object acquisition game machine) 104 of the paired player ID. Note that, if a pairing request is transmitted from an already paired player (user terminal 110) or if a pairing request for pairing with an already paired crane game machine (object acquisition game machine) 104 is transmitted from another player, the player managing unit 170 rejects a new pairing (which will be described later).

After the crane game is terminated, the crane game machine (object acquisition game machine) 104 transmits an unpairing request containing the game machine ID and the player ID to the server 102. At this point, the player managing unit 170 unpairs the pairing. For example, when an unpairing request is transmitted from the crane game machine (object acquisition game machine) 104 (C01) to the server 102, the player managing unit 170 unpairs the crane game machine (object acquisition game machine) 104 (C01) and the player (P02).

In another example, “provisional pairing setting” may be performed in S18, and the transmitting unit 166 of the server 102 may transmit a pairing check to the crane game machine (object acquisition game machine) 104. The display unit 192 of the crane game machine (object acquisition game machine) 104 may display a pairing check screen (not illustrated), and the transmitting unit 194 of the crane game machine (object acquisition game machine) 104 may notify the server 102 of a “pairing success” when the player has bought a credit or credits. The player managing unit 170 of the server 102 may set the pairing on the basis of receipt of this notification. The server 102 may transmit a completion notification to the user terminal 110 after the pairing is set (S20), and the CS software in the user terminal 110 may display a screen saying “You are logged in.” In this example, the process of S22 is unnecessary.

Details of the pairing will be further described.

The server 102 periodically generates a key code, and transmits the key code to the crane game machines (object acquisition game machines) 104. Each crane game machine (object acquisition game machine) 104 records the latest key code received from the server 102 into an internal memory. In the present embodiment, the code generating unit 206 of each crane game machine (object acquisition game machine) 104 generates a two-dimensional code 218 containing the game machine ID and the latest key code.

Alternatively, the sever 102, instead of the crane game machines (object acquisition game machines) 104, may generate a two-dimensional code 218. For example, the server 102 may transmit a two-dimensional code 218 (image) containing the latest key code and the game machine ID to each crane game machine (object acquisition game machine) 104, and the display unit 192 of each crane game machine (object acquisition game machine) 104 may display the two-dimensional code 218 received from the server 102 in the pairing setting region 216. Alternatively, each relay 108 may generate a two-dimensional code 218 containing the latest key code received from the server 102 and a game machine ID and transmit the two-dimensional code 218 to the corresponding crane game machine (object acquisition game machine) 104. The display unit 192 of the crane game machine (object acquisition game machine) 104 may display the two-dimensional code 218 received from the relay 108 in the pairing setting region 216.

Assume that the server 102 has generated a key code Q1 at time t1, a key code Q2 at time t2, which is a predetermined time after time t1, and further a key code Q3 at time t3, which is a predetermined time after time t2. After time t3, the crane game machine (object acquisition game machine) 104 displays a two-dimensional code 218 containing the key code Q3 in the pairing setting region 216.

Assume that a player has imaged a two-dimensional code 218 and sent a pairing request to the server 102. The player managing unit 170 of the server 102 establishes the pairing if the key code contained in the pairing request is the latest key code Q3 or the previously issued key code Q2. If the key code contained in the pairing request is too old, the player managing unit 170 does not permit the pairing. The key codes are a function for preventing establishment of improper pairing, which will be described in detail below.

In view of the above, a method for preventing “double pairing”, that is, pairing two or more players with one crane game machine (object acquisition game machine) 104 will be explained.

First, assume a case where a player (P02) and a player (P03) request pairing with the crane game machine (object acquisition game machine) 104 (C01). When the pairing of the player (P02) is established first (S22), the crane game machine (object acquisition game machine) 104 does not display a two-dimensional code 218 on the initial screen 210 until the crane game machine (object acquisition game machine) 104 is unpaired. Thus, once the pairing of the player (P02) and the crane game machine (object acquisition game machine) 104 (C01) is established, the player (P03) cannot image a two-dimensional code 218 at the crane game machine (object acquisition game machine) 104 (C01). This will be referred to as a “first double pairing preventing method”.

The player (P03) may have saved a two-dimensional code 218 that was previously imaged into his/her user terminal 110. In this case, the player (P03) may transmit a pairing request based on the previously imaged two-dimensional code 218, instead of the latest two-dimensional code 218 displayed on the crane game machine (object acquisition game machine) 104 (C01), to the server 102. In this case, double pairing key code is prevented on the basis of the “issuance timing”, as described above. This will be referred to as a “second double pairing preventing method”. For example, when the player (P03) has transmitted a pairing request containing the old key code Q1, which was acquired in the past, to the server 102 after time t3, the server 102 does not permit pairing of the player (P03) because the key code Q1 is too old. This control method reduces pairing requests based on old key codes.

In the next example, assume that a player (P02) and a player (P03) have imaged the same two-dimensional code 218 displayed on the initial screen 210 at substantially the same time and transmitted pairing requests from their individual user terminals 110 to the server 102. Then, if the server 102 has received the pairing request of the player (P02) earlier than the pairing request of the player (P03), the player managing unit 170 establishes the pairing of the player (P02) with the crane game machine (object acquisition game machine) 104 (C01), and the transmitting unit 166 transmits a connection failure notification to the user terminal 110 of the later player (P03). Upon receiving the connection failure notification, the user terminal 110 (P03) displays a screen indicating the connection failure. This will be referred to as a “third double pairing preventing method”.

Next, details of unpairing will be described.

When one play of the crane game is terminated, the crane controlling unit 200 automatically returns the crane 118 to a predetermined position (home position. When no credit is newly bought for a predetermined time after the remaining number of input credits became zero and the crane 118 returned to the home position, the pairing managing unit 208 of the crane game machine (object acquisition game machine) 104 deems that the player has left the crane game machine (object acquisition game machine) 104 and unpairs the pairing. This will be referred to as “first unpairing”. First, the pairing managing unit 208 unpairs the crane game machine (object acquisition game machine) 104. In the case of the first unpairing, the crane game machine (object acquisition game machine) 104 transmits an unpairing request to the server 102. The unpairing request contains the game machine ID and the player ID. Upon receiving the unpairing request, the player managing unit 170 of the crane game machine (object acquisition game machine) 104 unpairs the pairing. In this manner, the pairing is unpaired at both of the server 102 and the crane game machine (object acquisition game machine) 104.

In such cases where some failure has occurred in the crane game machine (object acquisition game machine) 104 after a play is terminated or where a player has difficulty in getting a prize, the player may call the administrator of the machine and ask for assistance to check the status. In this case, in order to avoid the first unpairing due to a lapse of a predetermined time, an operation means such as a switch operable only by the administrator may be provided inside the crane game machine (object acquisition game machine) 104 (such as the inside thereof reachable by opening the door 124) to temporarily stop or stop the clock.

The player can also unpair a pairing by touching an unpairing button (not illustrated) displayed on the setting display 144. When the player has touched the unpairing button, the pairing managing unit 208 unpairs the pairing. This will be referred to as “second unpairing”. In this case as well, the pairing managing unit 208 first unpairs the pairing. In the second unpairing, the crane game machine (object acquisition game machine) 104 also transmits an unpairing request to the server 102. Upon receiving the unpairing request, the player managing unit 170 of the crane game machine (object acquisition game machine) 104 unpairs the pairing.

In the first unpairing and the second unpairing, unpairing is first performed by the crane game machine (object acquisition game machine) 104 and is subsequently performed by the server 102 in accordance with an unpairing request. In some cases, however, an unpairing request transmitted from the crane game machine (object acquisition game machine) 104 may not reach the server 102 owing to communication failure between the server 102 and the crane game machine (object acquisition game machine) 104 or other reasons.

When pairing is established, the crane game machine (object acquisition game machine) 104 transmits a status signal containing a player ID to the server 102 as appropriate or periodically. Thus, after the first or second unpairing is performed, the crane game machine (object acquisition game machine) 104 transmits a status signal containing no player ID to the server 102.

For example, assume that a crane game machine (object acquisition game machine) 104 (C01) and a player (P02) have been paired. Thereafter, assume that no unpairing request from the crane game machine (object acquisition game machine) 104 (C01) has reached the server 102 although the first or second unpairing was performed. In this case, an “inconsistent status” in which the crane game machine (object acquisition game machine) 104 has unpaired the pairing but the server 102 has not unpaired the pairing occurs.

In order to resolve such an inconsistent status, when a status signal containing the player ID P02 has not been received from the crane game machine (object acquisition game machine) 104 (C01) for a predetermined time, such as 10 minutes, or longer, the player managing unit 170 unpairs the pairing without an unpairing request from the crane game machine (object acquisition game machine) 104 (C01). Thereafter, the server 102 is ready to receive a new pairing request. Such unpairing autonomously performed by the server 102 will be referred to as “third unpairing”.

Note that, after unpairing, the server 102 transmits an unpairing request to the crane game machine (object acquisition game machine) 104 so that the unpairing is also performed by the crane game machine (object acquisition game machine) 104 in order to enhance the reliability. As described above, the crane game machine (object acquisition game machine) 104 transmits an unpairing request to the server 102 when unpairing is initially performed by the crane game machine (object acquisition game machine) 104, and the server 102 transmits an unpairing request to the crane game machine (object acquisition game machine) 104 when unpairing is initially performed by the server 102, which achieves error control so that no “inconsistent status” of pairing will be left.

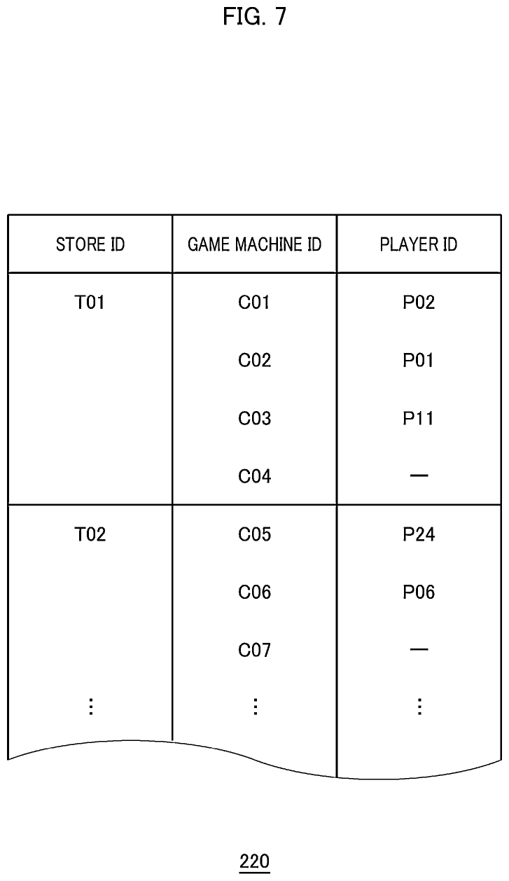

FIG. 7 is a data structure diagram of pairing information 220.

The pairing information 220 is stored in the data storage unit 164 of the server 102. Game machine IDs and store IDs are associated with each other in advance. Thus, the store in which each crane game machine (object acquisition game machine) 104 is installed is registered in the server 102.

Crane game machines (object acquisition game machines) 104 (C01) to 104 (C04) are installed in a store (T01) with a store ID T01. In addition, a crane game machine (object acquisition game machine) 104 (C05) is installed in a store (T02).

The crane game machine (object acquisition game machine) 104 (C01) is paired with a player (P02). The crane game machine (object acquisition game machine) 104 (C02) is paired with a player (P01). In addition, the crane game machine (object acquisition game machine) 104 (C04) is not paired with any player, and is therefore available to be played by any player. The player managing unit 170 registers pairing in the pairing information 220 when the pairing is established, and deletes the pairing from the pairing information 220 when an unpairing request is received.

### [Playpoint Function]

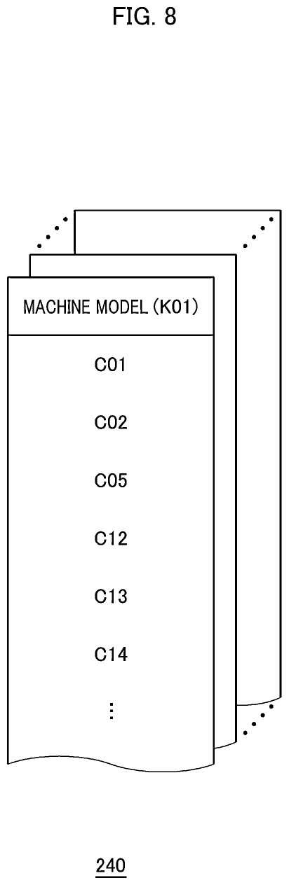

FIG. 8 is a data structure diagram of machine group information 240.

The machine group information 240 is stored in the data storage unit 164 of the server 102. The machine model of the crane game machine (object acquisition game machine) 104 is identified by a model ID. The machine group information 240 illustrated in FIG. 8 shows a list of crane game machines (object acquisition game machines) 104 corresponding to a model ID K01 (hereinafter referred to as “crane game machines (object acquisition game machines) 104 (K01)” and “model (K01)”). According to FIG. 8, the crane game machine (object acquisition game machine) 104 (C01), the crane game machine (object acquisition game machine) 104 (C02), the crane game machine (object acquisition game machine) 104 (C05), etc. are of the same model (K01).

The operator of the game system 100 sets a “campaign” for a specific model. In the description of the present embodiment, assume that the model (K01) is set as a model eligible for the campaign. The crane game machines (object acquisition game machines) eligible for the campaign include the crane game machine (object acquisition game machine) 104 (K01:C01), the crane game machine (object acquisition game machine) 104 (K01:C02), and the crane game machine (object acquisition game machine) 104 (K01:C05). The player can get points (first bonus) by playing with any of the crane game machines (object acquisition game machines) 104 of the model eligible for the campaign.

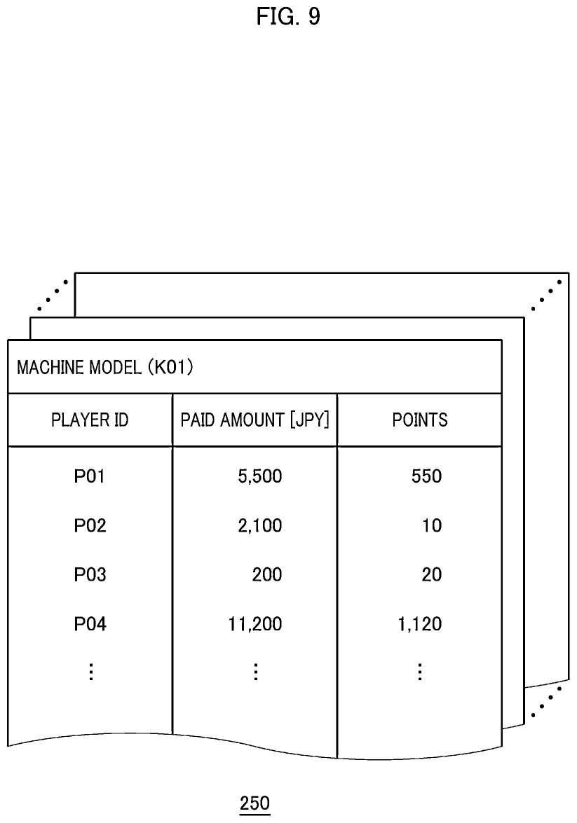

FIG. 9 is a data structure diagram of held point information 250.

The held point information 250 is stored in the data storage unit 164 of the server 102. The held point information 250 illustrated in FIG. 9 show a paid amount, which is a cumulative total of paid play fees, and points obtained as a result by each player of the model (K01). When a player (P01) has played the crane game machine (object acquisition game machine) 104 (C01), which corresponds to the model (K01) eligible for the campaign, the crane game machine (object acquisition game machine) 104 (C01) transmits play information to the server 102. As described above, the play information contains the game machine ID, the player ID, the price of a credit, and the like. The price of a credit is a play fee per play of the crane game machine (object acquisition game machine) 104 (C01). Because pairing is established before the play, the crane game machine (object acquisition game machine) 104 (C01) also includes the player ID P01 in the play information to be transmitted. The crane game machine (object acquisition game machine) 104 (C01) transmits play information for every play to the server 102.

The play information obtaining unit 230 of the server 102 receives the play information from each of the crane game machines (object acquisition game machines) 104. The player managing unit 170 adds up the paid amount for each model and each player. According to FIG. 9, the paid amount (cumulative total) paid for the crane game machine (object acquisition game machine) 104 (K01) by the player (P01) is 5,500 [JPY]. More specifically, when the player (P01) has played with the crane game machine (object acquisition game machine) 104 (K01:C01) for which the play fee is 100 [JPY], the player managing unit 170 adds 100 [JPY] to the paid amount for the player (P01) and the model (K01). When the player (P01) has played the crane game machine (object acquisition game machine) 104 (K01:C05) of the same model but is another machine for which the play fee is 200 [JPY], the player managing unit 170 adds 200 [JPY] to the paid amount for the model (K01).

The bonus providing unit 232 gives 10 points (pt) per a paid amount of 100 [JPY] to each player. Thus, every time the paid amount increases by 100 [JPY], a first bonus condition is satisfied, and 10 (pt) is given to the corresponding player. According to FIG. 9, because the paid amount of the player (P01) is 5,500 [JPY], the bonus providing unit 232 has given 550 (pt) to the player (P01). Every time the points a player has reach 100 (pt), the bonus providing unit 232 further gives one coupon to the player. In the present embodiment, a coupon is a type of note equivalent to 100 [JPY]. In a case of a crane game machine (object acquisition game machine) 104 for which a play fee is 100 [JPY], one credit can be bought by one coupon.

More specifically, every time the points the player (P01) has reach 100 (pt), the bonus providing unit 232 increments the number of coupons associated with the player (P01). The server 102 manages the number of coupons of each player. When the player (P01) is paired with a crane game machine (object acquisition game machine) 104, the transmitting unit 166 of the server 102 notifies the crane game machine (object acquisition game machine) 104 of the number of coupons the player (P01) has. The player (P01) instructs the crane game machine (object acquisition game machine) 104 to exchange coupons for credits within the number of coupons the player (P01) has. When the play fee is 200 [JPY], the credit managing unit 204 exchange two coupons for one credit. When a player has used one or more coupons, the server 102 subtract the number of used coupons from the remaining number of coupons.

As described above, a player can collect points by playing the crane game machines (object acquisition game machines) 104 multiple times, and get coupons by collecting points.

While a player is given coupons in exchange for collected points, a player can also get a prize by consuming the collected points. Note that points given per paid amount may vary with time or may be determined depending on a past paid amount, a status of prize acquisition, and the like of a player (P01) instead of being given per fixed amount.

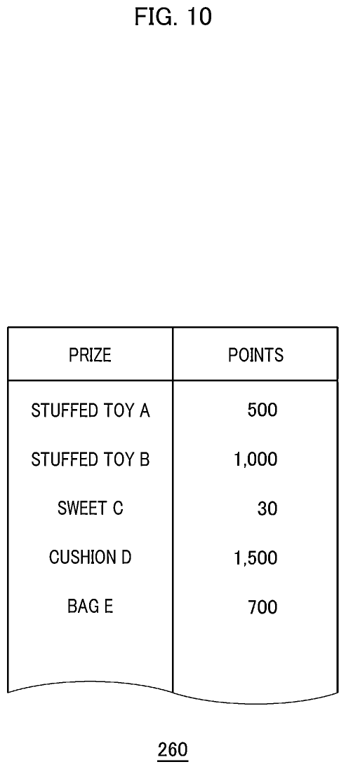

FIG. 10 is a data structure diagram of prize value information 260.

The prize value information 260 is stored in the data storage unit 164 of the server 102. As described above, a player can get points by playing a crane game with a model eligible for a campaign. Every time a predetermined number of points are collected, the bonus providing unit 232 gives a coupon to a player. Alternatively, a player can also exchange points for a prize (second bonus). The prize value information 260 shows the numbers of points corresponding to the values of various prizes.

A player can get a prize “stuffed toy A” by consuming 500 (pt). Thus, if a player can collect 500 (pt), a second bonus condition is satisfied, and the player acquires the right to get the prize “stuffed toy A”. A prize “cushion D” and a prize “bag E” can be exchanged for with 1,500 (pt) and 700 (pt), respectively. The prize value information 260 thus shows “values” of various prizes in points.

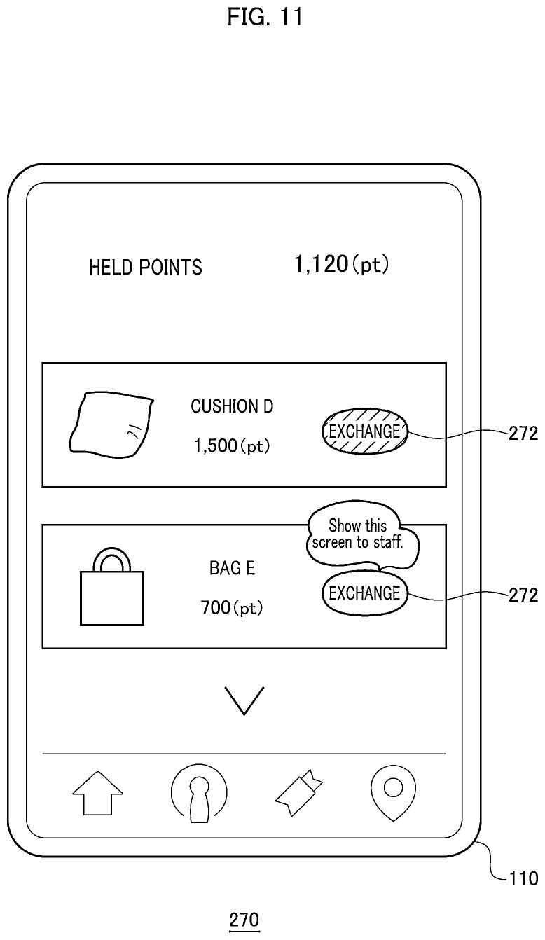

FIG. 11 is a screen diagram of prize exchange screen 270.

The prize exchange screen 270 is displayed on a user terminal 110 of each player registered as a member. When a player has accessed and instructed the server 102 from a user terminal 110 to display a member account page, the server 102 causes prize exchange screen 270 to be displayed on the user terminal 110. The player managing unit 170 of the server 102 refers to the held point information 250 and the prize value information 260 to generate the prize exchange screen 270. FIG. 11 illustrates the prize exchange screen 270 to be displayed on the user terminal 110 of a player (P04).

The player (P04) holds 1,120 (pt) (see FIG. 9). Because the value of the prize “cushion D” is 1,500 (pt), the player (P04) cannot acquire the prize “cushion D”. Thus, an exchange button 272 for instructing exchange for the cushion D grays out and is therefore unselectable.

In contrast, because the value of the prize “bag E” is 700 (pt), the player (P04) can acquire it. When the points held by the player (P04) is equal to or more than the value of a prize, the user terminal 110 displays the exchange button 272 in a selectable manner.

When the player (P04) wants the prize “bag E”, the player (P04) takes the user terminal 110 to an exchange shop located in a game arcade or the like, and shows the prize exchange screen 270 to a shop staff. The shop staff hands over the prize “bag E” to the player (P04) and touches, for the player (P04), the exchange button 272 associated with the prize “bag E”. As a result, the player ID, “700” points for the exchange, and the prize ID associated with the bag E are transmitted from the user terminal 110 to the server 102. The player managing unit 170 of the server 102 updates the held point information 250, and subtracts 700 (pt) from the held points of the player (P04). Through the processes described above, the player (P04) can exchange points (first bonus) for a prize (second bonus).

A shop staff may transmit the player ID and the prize ID of the prize for which the points are exchanged to from a shop terminal, instead of the user terminal 110 of the player, to the server 102 to cause the server 102 to update the held point information 250.

The game system 100 according to an embodiment has been described above.

A player performs the pairing process before playing a crane game. The player can readily perform the pairing process by only imaging the two-dimensional code 218 with the user terminal 110. As a result of the pairing, the server 102 can collect play information indicating “which player has played, how many times and which crane game machine (object acquisition game machine) 104 the player has played”.

When a player plays a crane game after the pairing, the server 102 automatically updates the held point information 250. The more the cumulative total of the paid amount is, the more points the player gets. Players can get coupons by collecting points. Players can also get various prizes by collecting points. Thus, even a player with a poor skill can surely get a bonus (reward) by continuing playing. Even if a player has lost a crane game, the amount paid for the crane game will not be an absolute waste.

Although a player can play a crane game without registration as a member, the membership registration allows a player to get bonuses depending on his/her play history. The mechanism of providing bonuses on the basis of play history encourages membership registration of players. Furthermore, points or bonuses such as prizes need not be provided while a crane game is being played, which makes it easy to keep high customer turnover rates of the crane game machines (object acquisition game machines) 104.

The present invention is not limited to the embodiment described above and modifications thereof, and any component thereof can be modified and embodied without departing from the scope of the invention. Components described in the embodiment and modifications can be combined as appropriate to form various other embodiments. Some components may be omitted from the components presented in the embodiment and modifications.

### [Modifications]

In the description of the embodiment, a player performs a pairing process for pairing with a crane game machine (object acquisition game machine) 104 before playing a crane game. In a modification, a crane game may be playable without a pairing process.

The CS software in the user terminal 110 may cause a two-dimensional code obtained by encoding the player ID to be displayed on a screen of the user terminal 110. A crane game machine (object acquisition game machine) 104 images the two-dimensional code with a camera included therein. Then, the crane game machine (object acquisition game machine) 104, instead of the user terminal 110, may transmit a pairing request containing the game machine ID and the player ID to the server 102.

A player may manually input the game machine ID of a crane game machine (object acquisition game machine) 104 into the user terminal 110. Alternatively, a player may manually input the player ID into a crane game machine (object acquisition game machine) 104. In this case as well, the user terminal 110 or the crane game machine (object acquisition game machine) 104 can transmit a pairing request containing the game machine ID and the player ID to the server 102.

In the description above, a player touches an unpairing button (not illustrated) of a crane game machine (object acquisition game machine) 104 so that the second unpairing is performed. In a modification, the second unpairing may be performed when a player has touched an unpairing button (not illustrated) displayed on a user terminal 110 by the CS application of the user terminal 110. Specifically, when a player touches an unpairing button on the user terminal 110, the user terminal 110 transmits an unpairing request containing the player ID to the server 102. The server 102 identifies a crane game machine (object acquisition game machine) 104 with which pairing of the specified player ID is established, and unpairs the pairing. The server 102 also transmits an unpairing request to this crane game machine (object acquisition game machine) 104 to also unpair the pairing at the crane game machine (object acquisition game machine) 104.

When a player has failed to acquire a prize in a crane game, the bonus providing unit 232 may give more points to the player than those given to a player who has won. The less skilled a player is, the more return points the player is likely to receive, which makes players more likely to be motivated to further attempt a crane game. The bonus providing unit 232 may give no points to a player who has won a prize in a crane game.

Conversely, the bonus providing unit 232 may give more points to a player who has won a prize in a crane game. Such a control can further enhance players' sense of achievement accompanying acquisition of a prize.

In the description of the embodiment, the bonus providing unit 232 gives points depending on a paid amount. The bonus providing unit 232 may vary points to be given depending on whether a player has won or lost a prize. Alternatively, the bonus providing unit 232 may give points depending on a cumulative total play time of a crane game.

In the description of the embodiment, a model for which points are given, or in other words, a model eligible for a campaign is set. In a modification, a campaign need not be set for a single model. For example, a crane game machine (object acquisition game machine) 104 (C01) and a crane game machine (object acquisition game machine) 104 (C03) that is of a model different from that of the crane game machine (object acquisition game machine) 104 (C01) may be eligible for the same campaign X. In this case, players can increase the points according to the campaign X when they played either of the crane game machine (object acquisition game machine) 104 (C01) and the crane game machine (object acquisition game machine) 104 (C03).

A store operator may set a campaign for all or some of crane game machines (object acquisition game machines) 104 installed in a store. Alternatively, one crane game machine (object acquisition game machine) 104 installed in a store may be set as a model for which points are to be given. Still alternatively, points may be given for all crane game machines (object acquisition game machines) 104 in all stores.

The bonus providing unit 232 gives points to a paired player. The bonus providing unit 232 gives no points to a player that is not paired, or a player that is not registered as a member. The server 102 may, however, collect play information on a player that is not registered as a member. Collection of play information is useful for analysis of play trends concerned with each crane game machine (object acquisition game machine) 104 even if players cannot be identified.

Players may be able to exchange points for prizes by operating the user terminals 110. When an instruction to exchange for a prize is issued by a user terminal 110, the server 102 may instruct a logistics company to deliver a prize to an address that is registered in advance by a player.

In the description of the embodiment, play information is transmitted from a crane game machine (object acquisition game machine) 104 to the server 102. In a modification, play information may be transmitted from a crane game machine (object acquisition game machine) 104 to a user terminal 110 via near field radio communication such as Bluetooth (registered trademark), and then transmitted from the user terminal 110 to the server 102.

1. A game system comprising:
a plurality of object acquisition game machines and a server,
wherein the server includes:
a play information obtaining unit configured to obtain play information containing a game machine ID for identifying an object acquisition game machine, a player ID for identifying a player, and a play result of an object acquisition game;
a key generating unit configured to generate a key code; and
a transmitting unit configured to transmit the key code to each object acquisition game machine,
wherein each of the object acquisition game machines includes:
a game field located in a play space and including a first area in which an object to be acquired is placed and a second area to which the object is to be moved;
an object holder configured to hold the object;
an operation unit configured to receive operation performed by a player;
a movement controlling unit configured to drive the object holder in accordance with the operation;
a movement determining unit configured to determine whether or not movement of the object to the second area is successful; and
a code generating unit configured to generate a code containing the key code and a game machine ID;
wherein the server further includes:
a receiving unit configured to receive a pairing request containing a key code, a game machine ID, and a player ID;
a player managing unit configured to check the key code and register pairing of the game machine ID and the player ID in the received pairing request; and
a bonus providing unit configured to give a bonus to a player when pairing of the player with the object acquisition game machine specified by the play information is registered and the play information satisfies a bonus condition.

2. The game system according to claim 1,
wherein, when an unpairing request containing the player ID and the game machine ID is received, the player managing unit of the server further unpairs the pairing.

3. The game system according to claim 1,
wherein the key generating unit of the server periodically updates the key code,
wherein when the server has updated the key code, the object acquisition game machine displays a code containing the updated key code, and
the player managing unit of the server registers pairing when the key code specified by the pairing request matches with a key code generated within a predetermined period.

4. A game system comprising:
a plurality of object acquisition game machines and a server,
wherein each of the object acquisition game machines includes:
a game field located in a play space and including a first area in which an object to be acquired is placed and a second area to which the object is to be moved;
an object holder configured to hold the object;
an operation unit configured to receive operation performed by a player;
a movement controlling unit configured to drive the object holder in accordance with the operation; and
a movement determining unit configured to determine whether or not movement of the object to the second area is successful,
wherein the server includes:
a play information obtaining unit configured to obtain play information containing a game machine ID for identifying an object acquisition game machine, a player ID for identifying a player, and a play result of an object acquisition game; and
a bonus providing unit configured to give a bonus to a player when a bonus condition based on the play information collected for the player is satisfied,
wherein when a machine model eligible for a bonus is set in advance to object acquisition game machines belonging to a group of a specific machine model set by an operator among the plurality of object acquisition game machines,
the bonus providing unit combines play information of a first player having played a first object acquisition game machine set as the machine model eligible for the bonus with play information of the first player having played a second object acquisition game machine also set as the machine model eligible for the bonus, and gives the bonus to the first player when the combined play information satisfies the bonus condition.

5. A server comprising:
a key generating unit configured to generate a key code;
a transmitting unit configured to transmit the key code to a plurality of object acquisition game machine;
a receiving unit configured to receive, from each of the object acquisition game machines, a pairing request containing the key code, a game machine ID for identifying the object acquisition game machine, and a player ID for identifying a player;
a player managing unit configured to check the key code and register pairing of the game machine ID and the player ID in the received pairing request; and
a play information obtaining unit configured to obtain, from each of the object acquisition game machines, play information containing the game machine ID, the player ID, and a play result of an object acquisition game; and
a bonus providing unit configured to give a bonus to a player when pairing of the player with the object acquisition game machine specified by the play information is registered and the play information satisfies a bonus condition.

6. A server comprising:
a play information obtaining unit configured to obtain play information containing a game machine ID for identifying one of a plurality of object acquisition game machines, a player ID for identifying a player, and a play result of an object acquisition game; and
a bonus providing unit configured to give a bonus to a player when a bonus condition based on the play information collected for the player is satisfied;
wherein when a machine model eligible for a bonus is registered in advance among the plurality of object acquisition game machines, the machine model including a first object acquisition game machine and a second object acquisition game machine,
the bonus providing unit combines play information of a first player having played the first object acquisition game machine with play information of the first player having played the second object acquisition game machine, and gives the bonus to the first player when the combined play information satisfies the bonus condition.
